(19) United States
(12) Patent Application Publication
(10) Pub. No.: US 2008/0049425 A1
(43) Pub. Date: Feb. 28, 2008

(54) Rotatable power supply apparatus

(76) Inventor: Fong-Shi Lin, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/507,433

(22) Filed: Aug. 22, 2006

(51) Int. Cl. F21S 13/14

(52) U.S. Cl. 362/252

(57) ABSTRACT

The invention relates to a rotatable power supply apparatus, which includes a shell and a cap for receiving an inner power supply. The apparatus also includes a connector and a cover for connecting any ornament with light string. The apparatus can provide power for the lighting ornament and rotates the ornament at the same time easily that obtains a utilized beautiful rotating decoration.

### BACKGROUND OF THE INVENTION

It is known to use some lighting ornaments for providing a beautiful indoor dressing. The conventional ornament usually includes a light string as the lighting means, which has an electrical wire connecting with many bulb assemblies. Because of the used light string, the known ornament cannot be a rotary one, since the electrical wire will be winded. Hence, the conventional lighting ornaments are almost static and cannot be rotated. It is a drawback to be improved.

### SUMMARY OF THE INVENTION

It is an object of the present invention to provide a rotatable power supply apparatus for rotating a lighting ornament, which solves the problem of the prior art and obtains improvement and utilization. Now, accompanying with the following drawings, the character of the present invention will be described here and after.

### BRIEF DESCRIPTION OF THE DRAWINGS

FIG. 1 is an exploded perspective view showing a rotatable power supply apparatus according to the present invention.

FIG. 2 is an assembled perspective view of FIG. 1.

FIG. 3 is a cross-sectional plan view of FIG. 2.

FIG. 4 is a plan view showing an embodiment connecting with a Christmas tree according to the present invention.

FIG. 5 is a plan view showing another embodiment connecting with a lantern according to the present invention.

### DETAILED DESCRIPTION OF THE PREFERRED EMBODIMENT

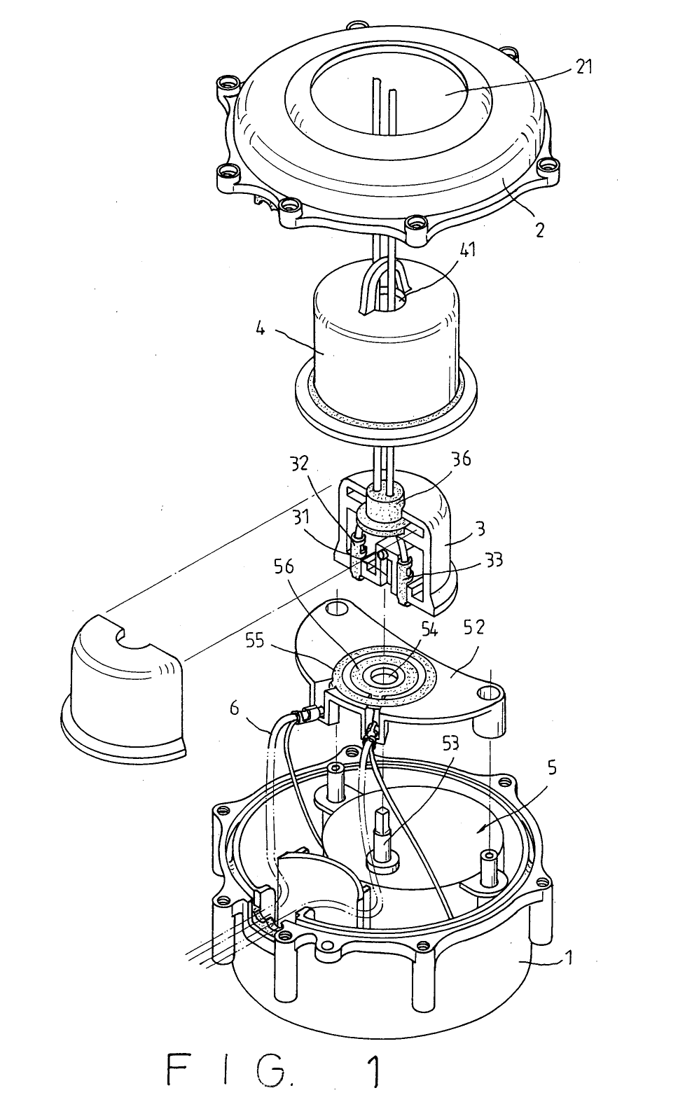

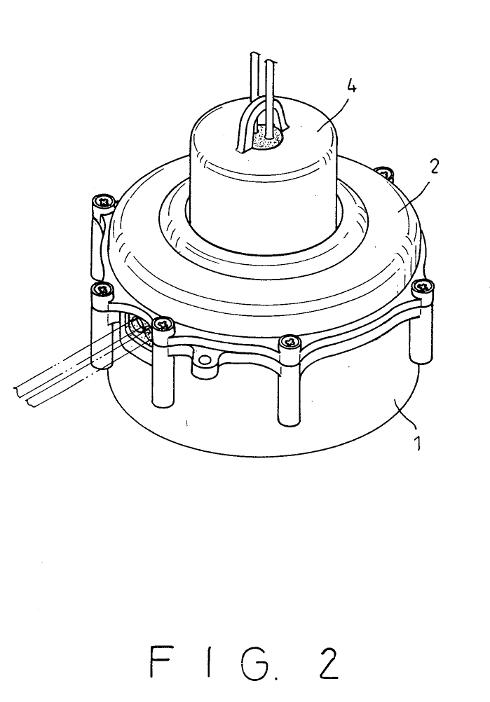

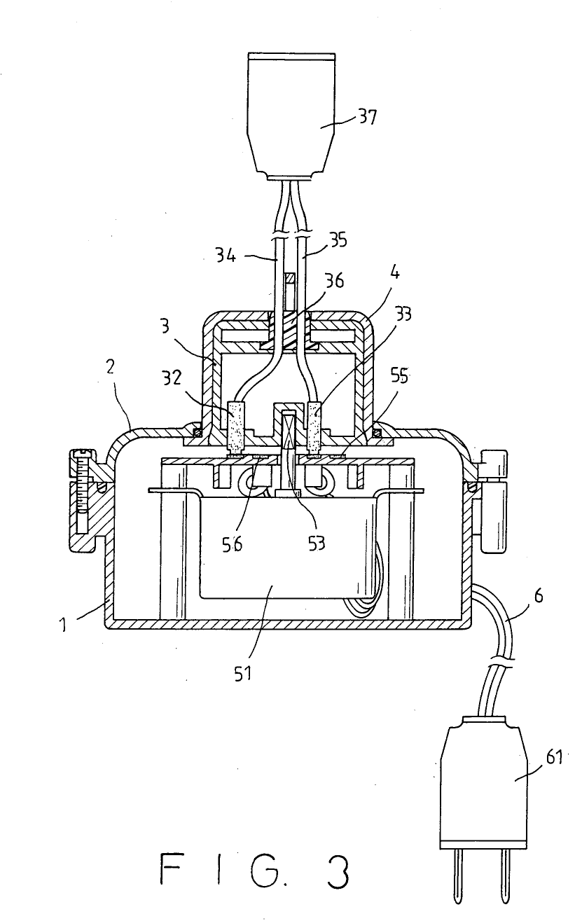

Referring to FIGS. 1 to 3, the present invention includes a shell (1), a cap (2), a connector (3), and a cover (4). A power supply (5) received in the shell (1) comprises a motor (51) and a frame (52), in which the motor (51) has its shaft (53) upward pass through an aperture (54) of the frame (52). The surface of the frame (52) is provided with an inner metal circle (56) and an outer metal circle (55), both of which connect to the motor (51) and a plug (61) by the wires (6).

The cap (2) mounted on the shell (1) has a central hole (21) for receiving the connector (3) and the cover (4). The connector (3) has an inner shaft-joint (31) to engage with the shaft (53) of the motor (51) and has two downward metal pins (32), (33) to contact two metal circles (55), (56) on the frame (52) respectively. The metal pins (32), (33) connect to electrical wires (34), (35) at upper ends, while the electrical wires (33), (34) are extended upward and penetrated through a rotor (36) to be jointed and formed a socket (37). The rotor (36) is positioned at upper end of the connector (3) and received in a hole (41) of the cover (4), which is placed outside the connector (3).

When the plug (61) connects to outer power source, the motor (51) begins rotating and then rotates to connector (3) and the cover (4). At the time, two pins (32), (33) rotates on two metal circles (55), (56) without separation. As two metal circles (55), (56) are electrified, the socket (37) becomes a power supply and is rotatable. Hence, the present invention becomes a rotatable power supply apparatus.

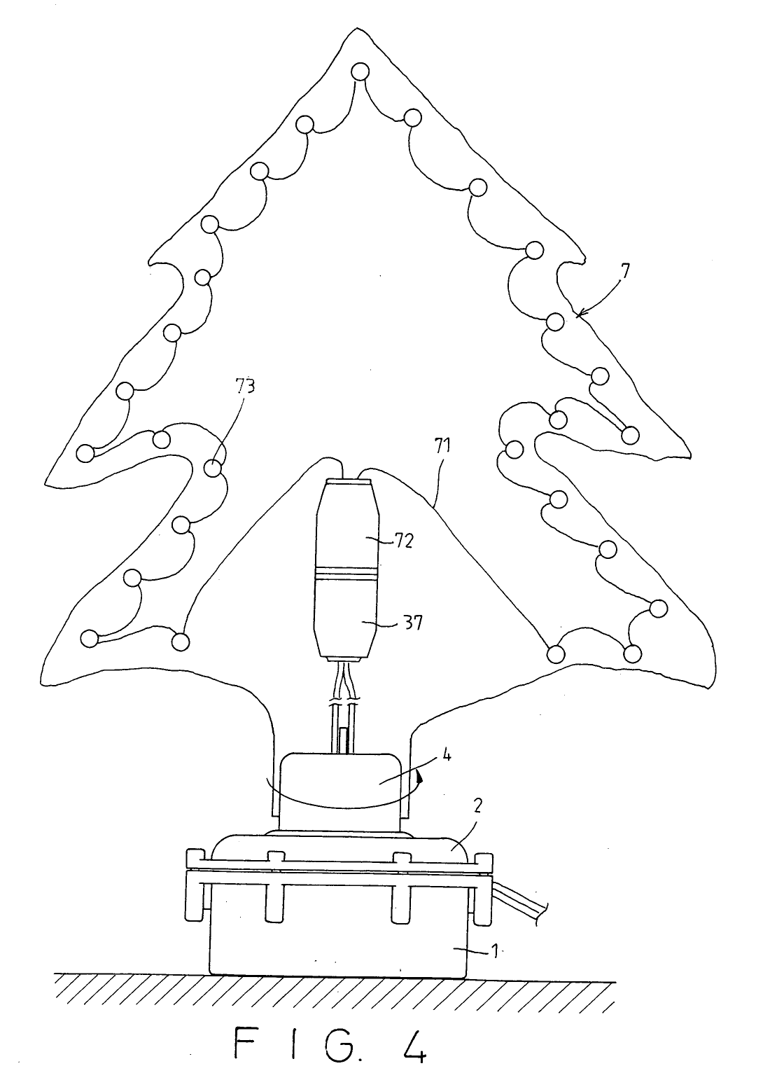

In application, FIG. 4 shows an embodiment, wherein a Christmas tree (7) is connected to the cover (4) of the apparatus. A light string (71) winded on the tree has its plug (72) connect to the socket (37). When the plug (61) of the wire (6) is connected to an outside power source, the bulbs (73) of the Christmas tree (73) are lightened and the tree (7) is rotated followed the cover (4). Thus, it reaches the effect of rotating and lighting at the same time.

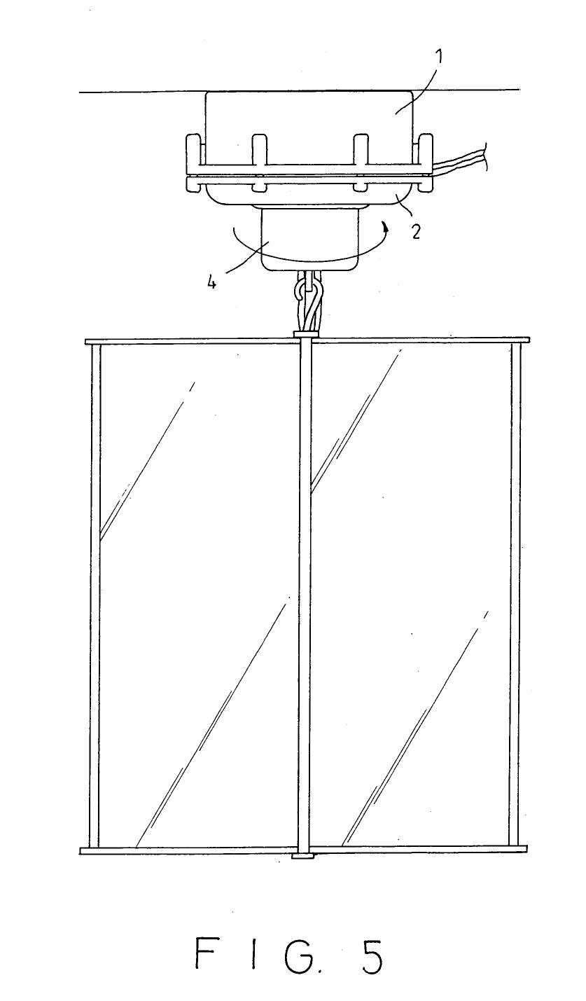

As shown in FIG. 5, it is another embodiment of the present invention to hang a lantern, which is rotatable when lighting without difficulty. It is to be understood that other embodiments can be applied is use of the present rotatable power supply apparatus. Hence; the present invention obviously obtains improvement and should be allowed for a patent.

I claim:

1. A rotatable power supply apparatus including a shell, a cap, a connector, and a cover, and a power supply received in the shell comprising a motor and a frame, in which the motor has its shaft upward pass through an aperture of the frame having an inner metal circle and an outer metal circle, both of which connect to the motor and a plug by the wires;
the cap mounted on the shell having a central hole for receiving the connector and the cover; the connector having a inner shaft-joint to engage with the shaft of the motor and having two downward metal pins to contact two metal circles on the frame respectively, and the metal pins connect to electrical wires at upper ends, while the electrical wires are extended upward and penetrated through a rotor to be jointed and formed a socket, wherein the rotor is positioned at upper end of the connector and received in a hole of the cover, which is placed outside the connector.

2. The rotatable power supply apparatus umbrella as claimed in claim 1, wherein the cover is to be connected with other ornaments and the socket is to be engaged with a plug of the light string winded on the ornament.
